(19) United States
(12) Patent Application Publication
(10) Pub. No.: US 2013/0236392 A1
(43) Pub. Date: Sep. 12, 2013

(54) Thermochemical Reactors and Processes for Hydrolysis of Cupric Chloride

(71) Applicants: Greg Naterer, St. John's (CA); Venkata Daggupati, Oshawa (CA); Kamiel S. Gabriel, Bewdley (CA); Zhaolin Wang, Whitby (CA); Robert J. Gravelsins, Mississauga (CA)

(72) Inventors: Greg Naterer, St. John's (CA); Venkata Daggupati, Oshawa (CA); Kamiel S. Gabriel, Bewdley (CA); Zhaolin Wang, Whitby (CA); Robert J. Gravelsins, Mississauga (CA)

(21) Appl. No.: 13/820,437

(22) PCT Filed: Mar. 30, 2011
(86) PCT No.: PCT/CA2011/000341

§ 371 Date: May 29, 2013

Related U.S. Application Data
(60) Provisional application No. 61/379,932, filed on Sep. 3, 2010.

(51) Int. Cl. B01J 8/18; B01J 8/02

(52) U.S. Cl. CPC B01J 8/18; B01J 8/02
USPC 423/648.1; 422/162

(57) ABSTRACT

A thermochemical reactor (4) and associated processes are disclosed. The reactor (4) and processes are used to conduct reactions relating to the hydrolysis of cupric chloride (CuCl2) within any one of the five-, four- and three-step Cu—Cl cycles. The reactor (4) comprises a reaction chamber (22) including a first zone (24) configured to conduct a spray operation and a second zone (26) configured to conduct a fluidized, fixed and/or moving bed operation. The first zone (24) includes a first inlet (28) configured to introduce a first reactant and an additional inlet (30) configured to introduce an additional reactant. A distributor (34) is configured to introduce the additional reactant to the second zone (26). One or more product outlets (44, 46) for communication with the reaction chamber (22) are provided.

### TECHNICAL FIELD

The disclosure relates generally to thermochemical processes, and more particularly to reactors and processes for hydrolysis of cupric chloride in a thermochemical copper-chlorine (Cu—Cl) cycle.

### BACKGROUND OF THE ART

Thermochemical water decomposition is an emerging technology for large-scale production of hydrogen. Typically using two or more intermediate compounds, a sequence of chemical and physical processes split water into hydrogen and oxygen, without releasing any pollutants into the atmosphere. These intermediate compounds are recycled internally within a closed loop. Previous studies have identified many possible thermochemical cycles. However, very few have progressed beyond theoretical calculations to working experimental demonstrations that establish scientific and practical feasibility of thermochemical processes.

The thermochemical Cu—Cl cycle includes a sequence of reactions to achieve the overall splitting of water into hydrogen and oxygen. Using intermediate copper chloride compounds, the Cu—Cl cycle decomposes water into hydrogen and oxygen, in a closed internal loop that recycles all chemicals on a continuous basis. Additional description of the Cu—Cl cycle is presented in U.S. Patent Publication Numbers 2010/0025260 A1 and 2010/0129287 A1.

Hydrolysis of cupric chloride (CuCl₂) is a key process within the Cu—Cl cycle. The reaction is an endothermic non-catalytic gas-solid reaction that operates between 350° C. and 420° C. The hydrolysis reaction leads to the decomposition of CuCl₂(solid) to produce copper oxychloride (CuOCuCl₂) and hydrochloric (HCl) gas. Existing hydrolysis equipment and processes reported in the literature have several drawbacks. For example, there has been no large engineering scale reactors demonstrated and tested. Existing equipment is also not configured to accommodate various process conditions and variants of the Cu—Cl cycle. For example, existing equipment cannot accommodate different forms of reactants and heat sources that may be used in conjunction with the Cu—Cl thermochemical cycle.

Improvement is therefore desirable.

### SUMMARY

The disclosure describes systems, devices, and methods useful in thermochemical processes. In particular, the disclosure describes systems, devices, and processes useful in the copper-chlorine (Cu—Cl) cycle.

In various aspects, for example, the disclosure describes a reactor for use in a thermochemical process. The reactor may comprise:
a reaction chamber having:
   a first zone comprising at least one first inlet to introduce a first reactant and at least one additional inlet to introduce an additional reactant, the inlets being configured to conduct a spray operation in the first zone; and
   a second zone in communication with the first zone;
a distributor to introduce the additional reactant to the second zone; and
at least one product outlet for communication with the reaction chamber.

The first zone of the reaction chamber may be configured to conduct one or more of a drying operation, a falling particle operation and a spray operation. The second zone of the reaction chamber may be configured to conduct one or more of a fluidized bed operation, a fixed bed operation and a moving bed operation.

According to another aspect, the disclosure describes a thermochemical process. The process may comprise:

introducing a first reactant and an additional reactant to a first zone of a reaction chamber and conducting a spray operation in the first zone;

receiving at least a portion of the first reactant and the additional reactant in a second zone of the reaction chamber; and

introducing more of the additional reactant to the second zone to obtain a product.

The reactants may include cupric chloride (CuCl₂) and water. CuCl₂ may be in the form of a solid, a slurry or an aqueous solution. Water may be in the form of a liquid and/or steam. The thermochemical process may include hydrolysis, for example.

The spray operation may include one or more of a drying operation, a falling particle operation and a spray operation. The introduction of more of the additional reactant may be used to conduct one of a fluidized bed operation, a fixed bed operation and a moving bed operation.

The process may comprise adding heat to the reaction chamber. Heat may be provided in the form of steam or a gas mixture such as an exhaust gas released from an unrelated industrial process.

According to another aspect, the disclosure describes a process for hydrolysis of cupric chloride (CuCl₂) for use in a thermochemical copper-chlorine (Cu—Cl) cycle. The process may comprise:

introducing cupric chloride and steam in a first zone of a reaction chamber and conducting a spray operation in the first zone;

receiving at least a portion of the cupric chloride and the steam in a second zone of the reaction chamber in communication with the first zone; and

introducing additional steam in the second zone to obtain a product in the reaction chamber.

The steam may be superheated. The process may comprise at least partially drying the cupric chloride in the first zone. The process may comprise fluidizing a bed in the second zone using the additional steam.

Further details of these and other aspects of the subject matter of this application will be apparent from the detailed description and drawings included below.

### DESCRIPTION OF THE DRAWINGS

Reference is now made to the accompanying drawings, in which:

FIG. 1 shows a detailed flow chart illustrating reactors, vessels, and equipment, where each step of a five-step Cu—Cl cycle may take place;

FIG. 2 shows a simplified flow chart illustrating reactors, vessels, and equipment, where each step of the five-step Cu—Cl cycle may take place;

FIG. 3 shows a simplified flow chart illustrating reactors, vessels, and equipment, where each step of a four-step Cu—Cl cycle may take place;

FIG. 4 shows a simplified flow chart illustrating reactors, vessels, and equipment, where each step of a three-step Cu—Cl cycle may take place;

FIG. 5 shows a schematic representation of a thermochemical reactor;

FIG. 6 shows a schematic representation of a feeding system which may be used to supply reactant(s) to the thermochemical reactor of FIG. 5;

FIG. 7 shows a top plan view of a distributor plate part of the thermochemical reactor of FIG. 5;

FIG. 8 shows a side elevation view of a distributor nozzle part of the thermochemical reactor of FIG. 5;

FIG. 9 shows a section view of the distributor nozzle of FIG. 8 along line 9-9 in FIG. 8;

FIG. 10 shows a schematic front elevation view of a cyclone separator which may be used to separate solid product(s) from gaseous product(s) exiting the thermochemical reactor of FIG. 5;

FIG. 11 shows a schematic partial left elevation view of the cyclone separator of FIG. 10;

FIG. 12 shows a schematic left elevation view of a circular to rectangular adaptor which may be used to establish fluid communication between the thermochemical reactor of FIG. 5 and the cyclone separator of FIG. 10; and

FIG. 13 shows a flow chart illustrating inputs and output(s) to the thermochemical reactor of FIG. 5 and a heat source.

### DETAILED DESCRIPTION OF THE PREFERRED EMBODIMENTS

Various aspects of preferred embodiments are described through reference to the drawings.

The Cu—Cl cycle performs a sequence of reactions to achieve the overall splitting of water into hydrogen and oxygen. Using intermediate copper chloride compounds, the cycle decomposes water into hydrogen and oxygen, in a closed internal loop that recycles all chemicals on a continuous basis. There are three key variations of the Cu—Cl cycle: five-step, four-step and three-step cycles. The Cu—Cl cycle is described in U.S. Patent Publication Numbers 2010/0025260 A1 and 2010/0129287 A1 which are incorporated herein by reference.

Table 1 lists the reactions associated with each step of the five-step Cu—Cl cycle.

TABLE 1
Five-step copper-chlorine (Cu—Cl) thermochemical cycle.

| | | Temperature |
|---|---|---|
| Step | Reaction | (° C.) |
| 1 | 2Cu (solid) + 2HCl (gas) = 2CuCl (molten) + H₂ | 430-475 |
| | (gas) | |
| 2 | 4CuCl (solution) = 2Cu (solid) + 2CuCl₂ (slurry or | 70-90 |
| | aqueous) in HCl acid | |
| 3 | (CuCl₂ + water, slurry or aqueous) = CuCl₂•nH₂O | 70-200 |
| | (solid) + water vapour (n could be an integer | |
| | between 0 and 5) | |
| 4 | 2CuCl₂ (solid) + H₂O (steam) = CuOCuCl₂ (solid) + | 350-420 |
| | 2HCl (gas) | |
| 5 | CuOCuCl₂ (solid) = 2CuCl (molten) + 0.5O₂ (gas) | 500-530 |

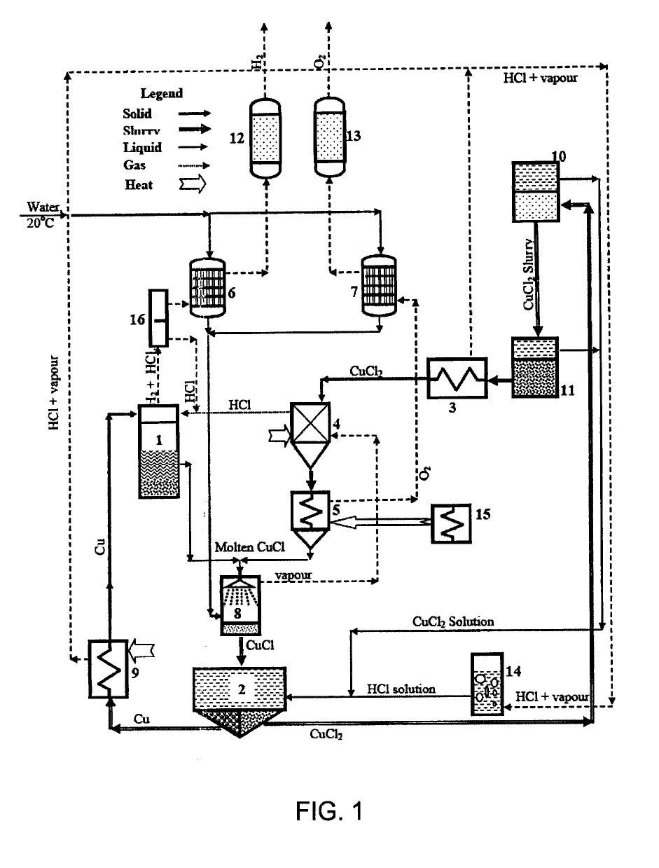

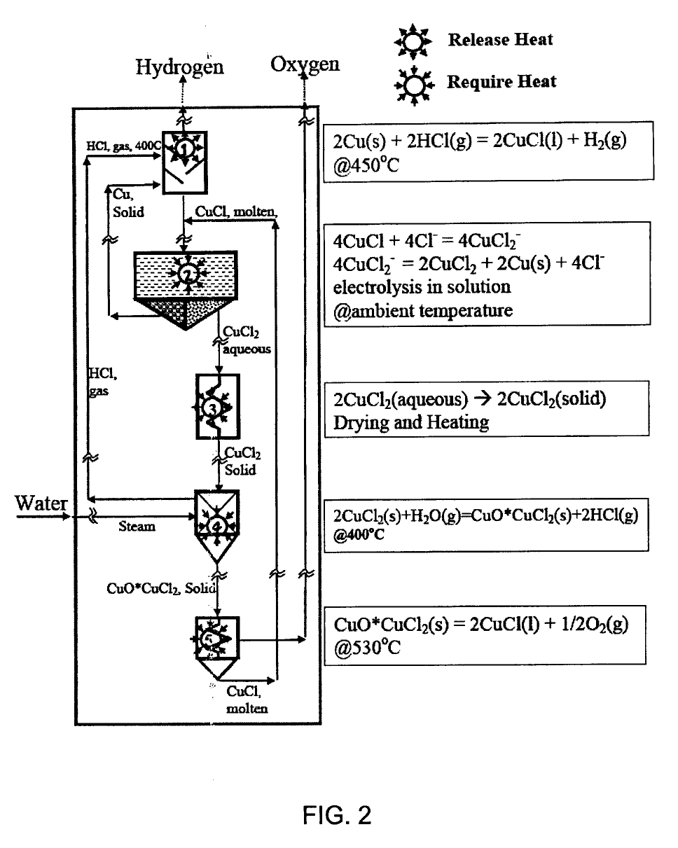

FIGS. 1 and 2 respectively show a detailed flow chart and a simplified flow chart illustrating reactors, vessels, and equipment, where each step of the five-step Cu—Cl cycle may take place. According to an exemplary embodiment of the Cu—Cl cycle, water, the only substance input to the cycle, may firstly enter heat exchangers 6 and 7 in the form of a liquid at ambient temperature to recover the heat from hydrogen gas (denoted as H₂) at a temperature of about 450° C. and oxygen gas (denoted as O₂) at a temperature of about 530° C., which pass through the respective heat exchangers 6 and 7. H₂ and O₂ may then be cooled to or near ambient temperature in purifiers 12 and 13, respectively.

At the outlets of each of the heat exchangers 6 and 7, water temperature may be much higher than ambient temperature, typically in the range from about 60° C. to about 100° C. The hot water may be pumped into a molten salt processing unit or steam generation column unit 8, wherein water may be evaporated and heated to a temperature of about 375° C. Simultaneously, molten salt at about 450° C. to about 530° C. produced from hydrogen production reactor 1 and oxygen production reactor 5 may be cooled and quenched in unit 8 to form a solid at a temperature from about 20° C. to about 90° C. The quenched CuCl may then be conveyed and fed into electrolysis reactor 2, wherein cupric chloride (CuCl₂) and copper (Cu) at a temperature from about 20° C. to about 90° C. may be produced. The reactions taking place in the reactors 1 and 2 may be described by steps (1) and (2), respectively of the five-step Cu—Cl cycle. The copper produced in electrolysis reactor 2 may then be conveyed with entrained water to dryer 9 where moisture is evaporated at from about 30° C. to about 120° C. After drying, the copper may then be conveyed and fed into the hydrogen production reactor 1 to produce hydrogen according to the reaction of step (1) of the five-step Cu—Cl thermochemical cycle.

The CuCl₂ produced in electrolysis reactor 2 may exist in a solution or dilute slurry. The solution or dilute slurry may be conveyed and fed into crystallization cell 10 wherein the solution or dilute slurry may be cooled to a lower temperature typically in the range from about 20° C. to about 35° C. so that much more solid CuCl₂ precipitates. After exiting crystallization cell 10, the CuCl₂ precipitate may go into separation cell 11 wherein the precipitate may be concentrated using natural sedimentation or centrifugal separation.

The solution of CuCl₂ separated from crystallization and separation cells 10 and 11, respectively, is recycled to unit 2. The CuCl₂ or its hydrated form exiting drying cell 3 may enter thermochemical reactor 4 wherein the hydrolysis reaction may take place to produce CuOCuCl₂ and HCl gas. The reaction that takes place in reactor 4 may be described in step (4) of the five-step Cu—Cl thermochemical cycle.

CuOCuCl₂ particles exiting reactor 4 may then be conveyed and fed into the oxygen production reactor 5, wherein the particles may decompose to O₂ and molten CuCl. The decomposition of CuOCuCl₂ may require heat, which can be provided by many ways such as from molten salt heat reservoir 15 for example.

The process taking place in oxygen production reactor 5 may be described in step (5) of the Cu—Cl thermochemical cycle. HCl gas exiting thermochemical reactor 4 may be pumped and fed into the hydrogen production reactor 1 wherein H₂ and molten CuCl are produced after HCl reacts with Cu. The process taking place in reactor 1 is described by step (1) of the five-step Cu—Cl cycle. The molten CuCl produced in hydrogen and oxygen production reactors 1 and 5 may be fed into molten salt processing and steam generation unit 8 and processed as described above. It is also noted that unreacted HCl gas may be present in the H₂ gas exiting the hydrogen production reactor 1. Accordingly, H₂ may be separated from HCl gas in H₂—HCl separator 16 before entering purifier 12.

During the drying processes taking place in dryers 3 and 9, the vapour and HCl obtained may be fed into reservoir 14. This way, the vapour and HCl may be recycled.

The flexibility of the Cu—Cl thermochemical cycle is such that some steps of the five-step cycle may be combined in different ways to provide closed cycles of varying length and steps. For example, a four-step Cu—Cl cycle may be achieved by combining steps (4) and (5) of the five-step cycle. Accordingly, some cells shown in FIG. 1 and their corresponding processes could be combined so that the overall process comprises fewer cells. Table 2 lists the reactions associated with each step of the four-step Cu—Cl thermochemical cycle.

TABLE 2
Four-step copper-chlorine (Cu—Cl) thermochemical cycle.

| | | Temperature |
|---|---|---|
| Step | Reaction | (° C.) |
| I | 2Cu (solid) + 2HCl (gas) = 2CuCl (molten) + H₂ | 430-475 |
| | (gas) | |
| II | 4CuCl (solution) = 2Cu (solid) + 2CuCl₂ (slurry or | 70-100 |
| | aqueous) in HCl acid | |
| III | 2(CuCl₂ + water, slurry or aqueous) + xH₂O | 350-420 |
| | (steam) = CuOCuCl₂ (solid) + 2HCl (gas) + H₂O | |
| | (excess steam) | |
| IV | CuOCuCl₂ (solid) = 2CuCl (molten) + 0.5O₂ (gas) | 500-530 |

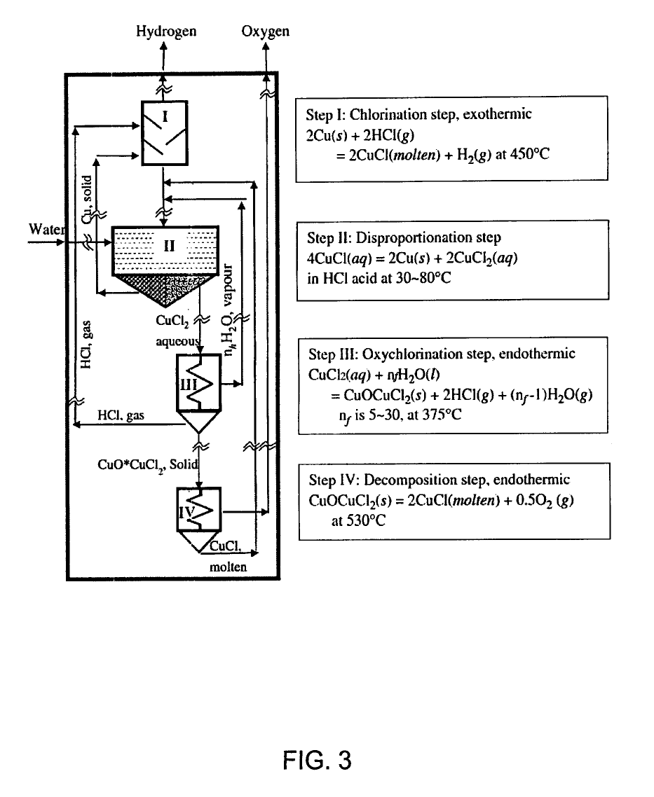

FIG. 3 shows a simplified flow chart illustrating the reactors, vessels, and equipment, where each step of the four-step Cu—Cl cycle may occur. The combination of steps (3) and (4) of the five-step cycle may provide advantages. One advantage may be the reduced transport and handling of solid particles. For example, in the drying step (3) of the five-step cycle, water in the form of liquid is removed from CuCl₂ solution to obtain anhydrous or dry hydrated CuCl₂. However, in the subsequent hydrolysis step (4), water in the form of gas (i.e. steam) is required as a reactant. Therefore, steps (3) and (4) of the five-step Cu—Cl cyle may be combined to form a four-step Cu—Cl cycle. Past investigations of reaction kinetics of the hydrolysis step (4) indicate that the hydrolysis step is a reversible reaction and the quantity of H₂O must be in excess of the stoichiometric quantity, in order to reach the stoichiometric yield of CuOCuCl2 or HCl.

A three-step Cu—Cl thermochemical cycle may also be achieved by combining steps (3), (4) and (5) of the five-step cycle. Table 3 lists the reactions associated with each step of the three-step Cu—Cl thermochemical cycle.

TABLE 3
Three-step copper-chlorine (Cu—Cl) thermochemical cycle.

| | | Temperature |
|---|---|---|
| Step | Reaction | (° C.) |
| i | 2Cu (solid) + 2HCl (gas) = 2CuCl (molten) + H₂ | 430-475 |
| | (gas) | |
| ii | 4CuCl (solution) = 2Cu (solid) + 2CuCl₂ (slurry) in | 70-90 |
| | HCl acid | |
| iii | 2CuCl₂ + H₂O + free/associated H₂O = 2CuCl | 500-530 |
| | (molten) + 0.5O₂ (gas) + 2HCl (gas) + free/ | |
| | associated H₂O | |

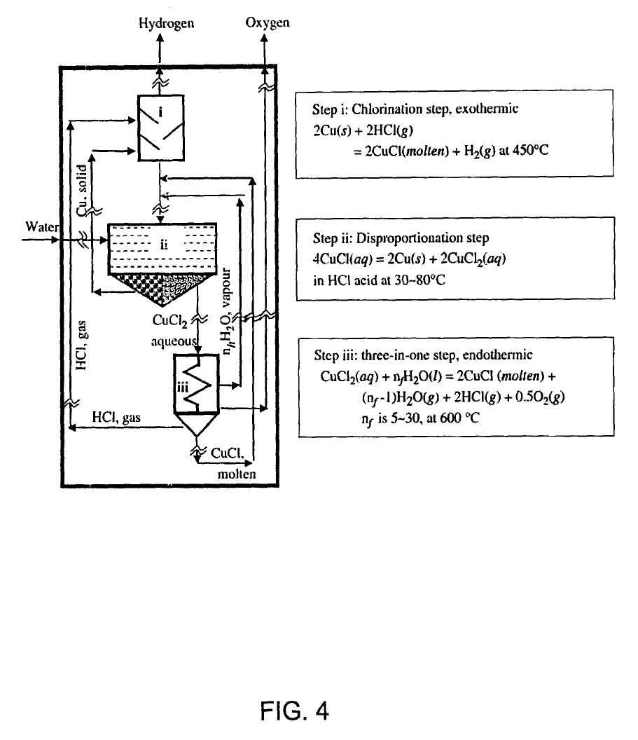

FIG. 4 shows a simplified flow chart illustrating the reactors, vessels, and equipment, where each step of the three-step Cu—Cl cycle may occur. Advantages associated with reduction to a three-step cycle are similar to those associated with reduction of the five-step to four-step cycle. Another reason to combine steps (3), (4) and (5) of the five-step cycle is that all three steps are endothermic, so they may be conducted in a single reactor. However, the disadvantages are more significant than those discussed in the reduction from a five-step to four-step cycle. The heat grade in steps (3) and (4) of the five-step cycle may have to be raised to 600° C. in step (iii) in order for the reaction to take place spontaneously.

Other variants of the five-, four- and/or three-step CU—Cl cycles could also be used in conjunction with the devices and processes of the present disclosure. For example, a variant of the three-step cycle may comprise the steps of: (iₐ) subjecting CuCl and HCl aqueous solution at a temperature of about 70° C. to about 90° C. to obtain H₂ and an aqueous slurry/solution containing HCl and CuCl₂; (iiₐ) heating the solid CuCl₂ and water to obtain solid CuOCuCl₂ and gaseous HCl; and (iiiₐ) heating the aqueous slurry containing HCl and CuCl₂ at a temperature from about 500° C. to about 530° C. to obtain molten CuCl salt and oxygen gas.

Regardless of whether the five-, four- or three-step Cu—Cl cycle is used, the hydrolysis reaction may always be present. The CuCl₂ may be introduced into thermochemical reactor 4 in form(s) of solid, slurry or aqueous solution, and water may be introduced in the form of liquid or steam. The reaction taking place in reactor 4 may be represented by equation (1) shown below.

CuCl₂(solid, slurry or solution)+H₂O(liquid or steam)=CuOCuCl₂(solid)+2HCl(gas)at 350-420° C. (1)

As described above, step 4 of the five-step Cu—Cl cycle is a hydrolysis process wherein steam reacts with cupric chloride particles to produce HCl gas and copper oxychloride feed for molten salt reactor 8. Drying of CuCl₂ solution can be performed separately in a spray dryer, prior to entering thermochemical reactor 4. Alternatively, in relation to the five-, four- and three-step Cu—Cl cycle, partial or complete reactive spray drying of liquid CuCl₂ may be performed by combining the hydrolysis reaction with spray drying.

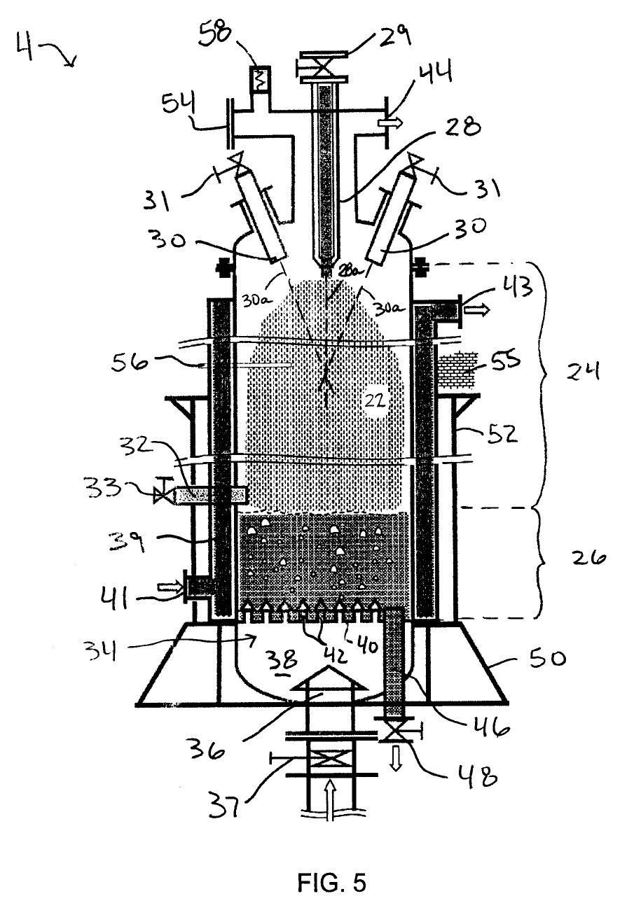

FIG. 5 shows a schematic representation of thermochemical reactor 4 which may be used for the hydrolysis of CuCl₂. It is understood that reactor 4 could also be used for the hydrolysis of other compounds such as municipal solid wastes and waste pickle liquor from metal pickling plants for example. In the hydrolysis of municipal solid wastes, some toxic chlorides may be hydrolyzed so that the toxicity is reduced. In the hydrolysis of waste pickle liquors, hydrochloric gas (HCl) may be recovered for reuse.

Reactor 4 may comprise reaction chamber 22 including first zone 24 for conducting a first operation and second zone 26 for conducting a second operation. In some applications, first operation and second operation may be conducted simultaneously. Reaction chamber 22 may have a cylindrical or other configuration. Second zone 26 may be in fluid communication with first zone 24. Second zone 26 may also be configured to receive at least some of the reactants from first zone 24 following the first operation. First zone 24 may be configured to perform a drying operation, a spray operation and/or a falling particle operation. Second zone 26 may be configured to perform fluidized, fixed and/or moving bed operations.

Reactor 4 may also comprise at least one reactant inlet for injecting reactants into first zone 24 and/or second zone 26. Reactant inlets may include primary inlet(s) 28, dispersion inlet(s) 30 and secondary inlet(s) 32. Reactant inlets 28, 30 and 32 may be configured to introduce a first reactant and/or a second (additional) reactant in first zone 24 and/or second zone 26 of reaction chamber 22.

Valve 29 may be used to control the flow of one or more reactants through primary inlet 28. Valves 31 may be used to control the flow of reactant through respective dispersion inlets 30. Similarly, valve 33 may be used to control a flow of reactant through secondary inlet 32.

Reactor 4 may include distributor 34 directed towards second zone 26 and one or more product outlets 44 and 46 in fluid communication with reaction chamber 22. Distributor 34 may be configured to introduce reactant (e.g. additional second reactant such as steam or other suitable gas mixture) in second zone 26. Accordingly, distributor 34 may have any configuration suitable for conducting a fluidized, fixed and/or moving bed operation in second zone 26. For example, distributor 34 may include distributor inlet 36 leading to buffer chamber 38 and distributor plate 40 serving as a separation between reaction chamber 22 and buffer chamber 38. The height of buffer chamber 38 may depend on the structure of buffer chamber 38 and on the diameter of reaction chamber 22. Buffer chamber 38 may have a hemispherical or ellipsoid shape. One or more distributor nozzles 42 may be disposed on distributor plate 40. Distributor nozzles 42 may be directed towards second zone 26 of reaction chamber 22. Valve 37 may be used to control the flow through distributor inlet 36. Distributor inlet 36 may be capped in order to more evenly distribute the gas stream inside buffer chamber 38 and to avoid the direct impingement of the gas stream onto distributor plate 40.

Product outlets may include gas outlet(s) 44 and solid outlet(s) 46. It is understood that gas outlet 44 may be used to mainly collect product in gaseous form but may also contain some product in at least one other form. Similarly, solid outlet 46 may be used to mainly collect product in solid form but may also contain some product in at least one other form. Solid outlet 46 may comprise a downcomer extending from distributor plate 40. A flow control device such as valve 48 may be used to prevent or control the flow of product through solid outlet 46.

Reactor 4 may comprise means for adding heat into the reaction chamber 22. Accordingly, reactor 4 may include heating jacket 39 at least partially surrounding reaction chamber 22. Heating jacket 39 may include inlet 41 and outlet 43 for allowing a suitable heating medium to flow through heating jacket 39 and transfer heat through a wall of reaction chamber 22. The heating medium may include steam, exhaust gas(es) from another process or any suitable working fluid.

Depending on the specific configuration of reactor 4, reactor 4 may comprise suitable base 50 and support frame 52 for supporting reactor 4 and/or various components thereof. Thermal insulation 55 may be disposed at various regions of reactor 4 to at least reduce heat loss to the environment from any component of reactor 4.

Maintenance port(s) 54 may be provided at desired location(s) on reactor 4. For example, maintenance port 54 may be disposed to allow access to gas outlet 44 and primary inlet 28. For the purpose of monitoring and potentially controlling the reaction(s) taking place inside reaction chamber 22, sensor(s) 56 may be provided at selected region(s) of reactor 4. For example, sensor(s) 56 may include one or more temperature sensors and/or one or more pressure sensors. As a safety precaution, pressure relief valve(s) 58 may be provided on reactor 4 to prevent a dangerously high pressure from building up within reaction chamber 22 or any part of reactor 4.

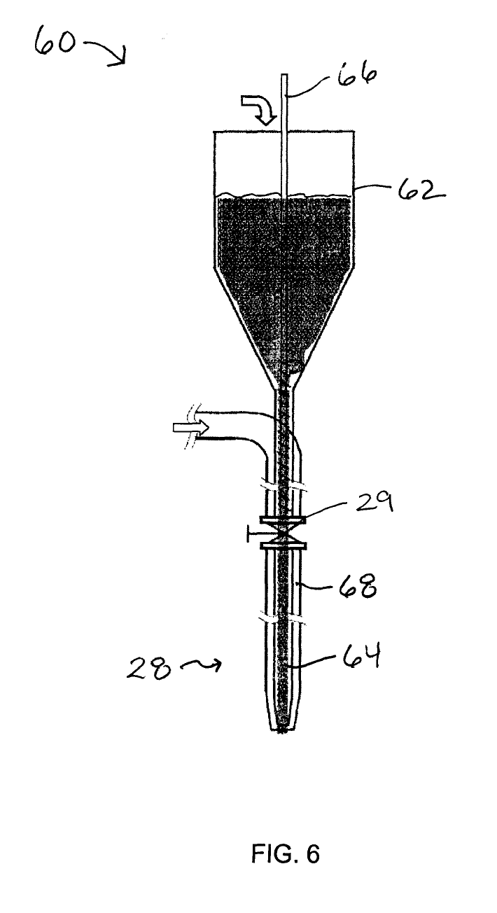

FIG. 6 illustrates a feeding system, generally shown at 60, which may be used to supply reactant(s) to primary inlet 28. Feeding system 60 may include hopper 62 for containing a supply of reactant(s) in the form of solid particles, slurry or aqueous solution. Hopper 62 may lead to inner passage 64 of primary inlet 28 and through which reactant(s) from hopper 62 may be fed. Screw conveyor 66 (e.g. auger) may be used to convey reactant(s) from hopper 62 into inner passage 64 towards primary inlet 28. Screw conveyor 66 may be driven by a motor (not shown) to achieve a desired feed rate of reactant(s). If the reactant is dry CuCl₂ particles that are smaller than 250 microns, screw conveyor 66 may not be required.

At least a portion of inner passage 64 may be disposed within outer passage 68. Accordingly, primary inlet 28 may have a coaxial configuration to permit injection of a first reactant through central passage 64 and a second (additional) reactant through outer passage 68 surrounding the central passage 64. Primary inlet 28 may not necessarily be of coaxial configuration but may also have any other configuration suitable to permit the simultaneous injection two or more reactants into reaction chamber 22. In order to prevent the decomposition of CuCl₂ particles inside inner passage 64 of primary inlet 28 due to the high temperature environment, the double shell structure of primary inlet 28 may be adopted to permit a lower temperature carrier gas (<250° C.) to flow and to be injected into reactor 4. The carrier gas may include nitrogen, argon, carbon dioxide, and/or steam. The flow of carrier gas may disperse the particles or slurries as they enter reactor 4 and also prevent CuCl₂ particles from clogging primary inlet 28.

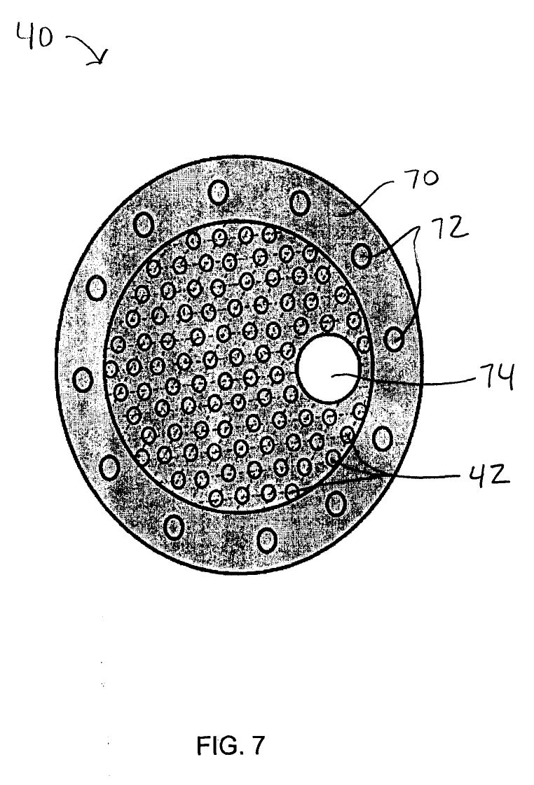

FIG. 7 illustrates a top plan view of distributor plate 40. Distributor plate 40 may include outer flange 70 and mounting holes 72 for attachment to suitable structure of reactor 4. For example, flange 70 may be used to attach distributor plate 40 to walls of reaction chamber 22. On a side facing second zone 26 of reaction chamber 22, distributor plate 40 may contain one or more distributor nozzles 42. Distributor nozzle(s) 42 may be disposed on distributor plate 40 according to a rhomboid pattern to provide uniform gas distribution over distributor plate 40. Distributor nozzle(s) 42 may be positioned according to other patterns such as triangular or square arrays so long as the gas is distributed uniformly. A total perforation ratio for distributor plate 40 may be in the range of 1-45% of the area of distributor plate 40. A preferred total perforation ratio may be in the range of 5-20%. Distributor plate 40 may also comprise outlet opening 74 in communication with solid product outlet 46.

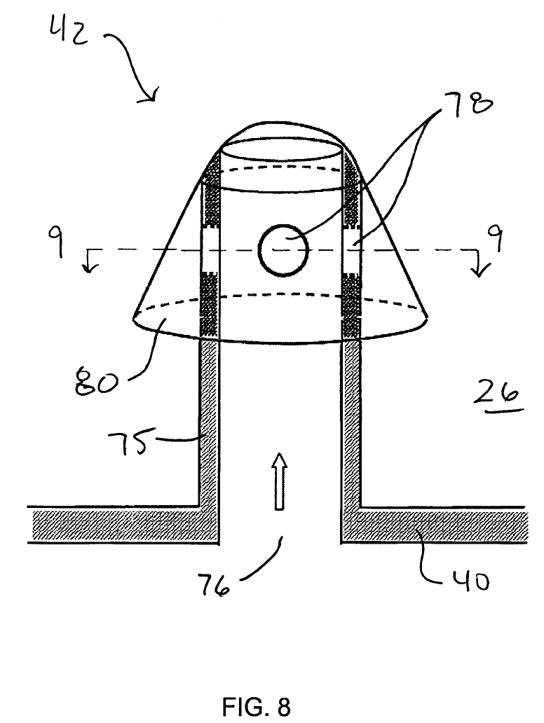

FIG. 8 illustrates a side elevation view of an exemplary distributor nozzle 42. Distributor nozzle(s) 42 may have any conventional or other configuration suitable for conducting a fluidized bed, fixed bed and/or moving bed operation in second zone 26. For example, distributor nozzle 42 may include nozzle body 75, nozzle inlet 76, one or more nozzle outlets 78 and nozzle cap 80. Nozzle cap 80 is shown to be partially transparent in FIG. 8. Nozzle cap 80 may be used to prevent reactant(s) from secondary zone 26 from exiting secondary zone 26 through distributor nozzle 42. Accordingly, nozzle cap 80 may be of conical or other suitable shape(s). The diameter of nozzle inlets 76 and the number of distributor nozzle(s) 42 may be selected to meet the requirements of the perforation ratio of distributor plate 40. Accordingly, the diameter of nozzle inlets 76 may be in the range of 0.5-15 cm and preferably in the range of 2-5 cm, depending on the perforation ratio and the diameter of reaction chamber 22. The diameter and the number of nozzle outlets 78 may be selected so that the pass-through area provided by nozzle outlets 78 on each distributor nozzle 42 is either equal to or slightly larger (within 30% larger) than the pass-through area provided by nozzle inlets 76 so that the performance of distributor plate 40 can simply be characterized using the perforation ratio.

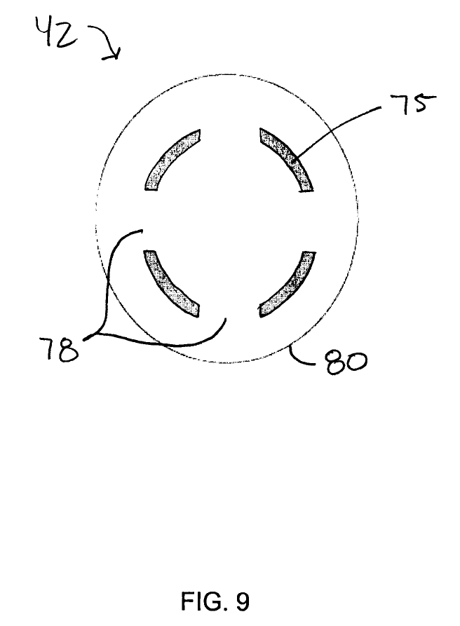

FIG. 9 illustrates a section view of distributor nozzle 42 along line 9-9 in FIG. 8. Four nozzle outlets 78 may be provided on nozzle body 75. Nozzle outlets 78 may be circumferentially distributed around nozzle body 75.

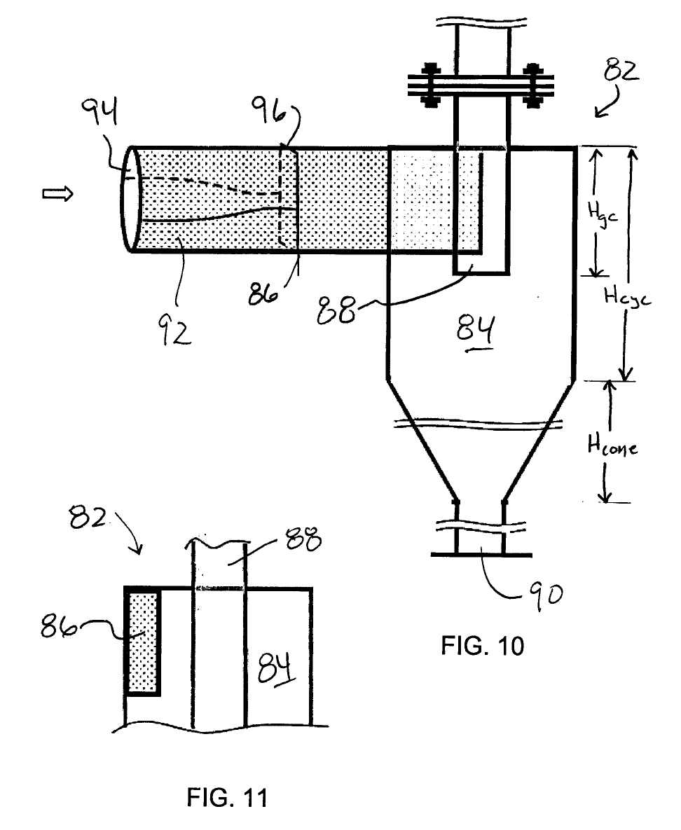

FIG. 10 illustrates a front elevation view of cyclone separator 82 which may be used to separate solid product(s) from gaseous product(s) exiting gas product outlet 44 of reactor 4. Cyclone separator 82 may include cyclone chamber 84, product inlet 86, gas collector 88, and solids collector 90. Product inlet 86 may have a rectangular cross-section to promote tangential flow of the gas and solid mixture within cyclone chamber 84. Circular to rectangular adaptor 92 may be required for delivering product(s) from gaseous product outlet 44 of reactor 4 to product inlet 86 of cyclone separator 82.

The diameter of gas collector 88 may be 10-60% of the maximum diameter of cyclone chamber 84 and preferably between 30-50% of the maximum diameter of cyclone chamber 84. Similar values may be applicable to the diameter of solids collector 90. Dimension H_{gc} of gas collector 88 extending into cyclone chamber 84 may be 10-50% of dimension H_{cyc} of cyclone chamber 84 and preferably between 20-30% of dimension H_{cyc} of cyclone chamber 84. Dimension H_{cone} may be 60% to 150% of the maximum diameter of cyclone chamber 84. For large lab scale hydrogen production at the level of 0.03-5.0 kg hydrogen per day, dimension H_{cyc} may be required to be between 0.1-0.5 meter and preferably around 0.3 meter. The maximum diameter of cyclone chamber 84 for the large lab scale production may be between 0.1-0.3 meter and preferably around 0.25 meter. For industrial hydrogen production at the scale of 50-200 tons per day, dimension H_{cyc} may be in the range of 3-20 meters (preferably around 5-10 meters) and the maximum diameter of cyclone chamber 84 may be in the range of 0.8-4 meters (preferably around 1.5-3 meters).

FIG. 11 illustrates a partial left elevation view of cyclone separator 82. Product inlet 86 may be positioned radially outward within cyclone chamber 84 so as to promote tangential flow of product(s) within the at least partially cylindrical cyclone chamber 84.

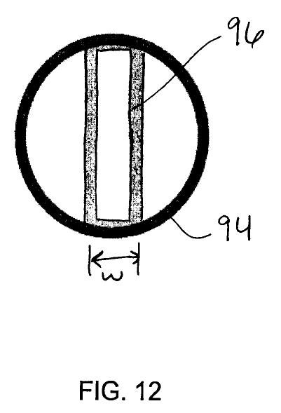

FIG. 12 illustrates a left elevation view of circular to rectangular adaptor 92. As explained above, adaptor 92 may have a circular end 94 for adapting to gaseous product outlet 44 of reactor 4 and a rectangular end 96 for adapting to product inlet 86 of cyclone separator 82. The width W of product inlet 86 may be 10-40% of the maximum diameter of cyclone chamber 84 and preferably between 20-30% of the maximum diameter of cyclone chamber 84.

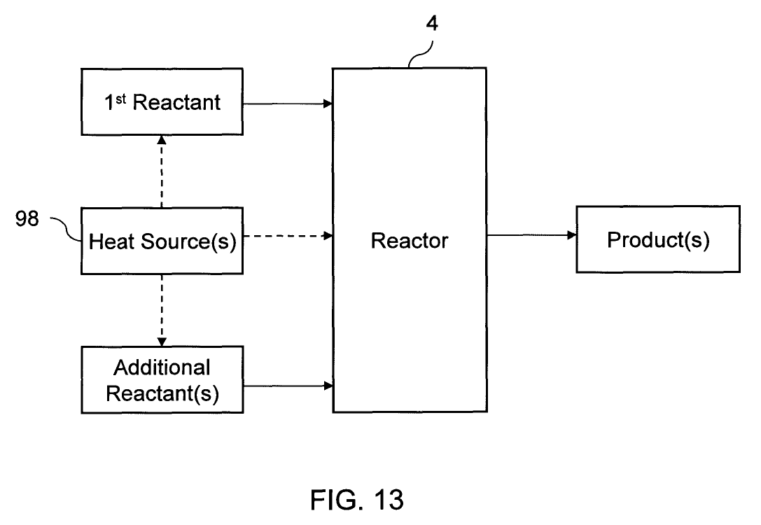

FIG. 13 is flow chart illustrating thermochemical reactor 4 into which a first reactant and at least one additional reactant(s) are introduced and at least one product(s) is obtained. Heat source(s) 98 may optionally provide heat directly to the reactor and/or provide heat to any one of the first reactant and the additional reactant(s). Source(s) 98 may include one or more industrial processes which may be unrelated to the Cu—Cl cycle and which may produce waste heat. For example, source(s) 98 may include one or more of a nuclear process, solar source, hydrocarbon combustor and/or engine, gas power plant, turbine, bitumen upgrader and refinery. One skilled in the relevant arts will recognize that sources of heat other than those listed above may also be suitable.

During operation, thermochemical reactor 4 may be used to conduct reactions or operations relating to the hydrolysis of cupric chloride within any one of the five-, four- and three-step Cu—Cl cycles. Reactor 4 may provide versatility such that the same reactor 4 may be used to conduct various operations or various combinations of operations depending on which Cu—Cl cycle is used. Reactor 4 may also accommodate various forms of water and CuCl₂. Water for the hydrolysis process may be provided in the form of liquid or steam. CuCl₂ feedstock may be provided in the form of solid particles, slurry or an aqueous solution depending on which variant of the Cu—Cl cycle is used. Accordingly, reactor 4 may accommodate gas-liquid, gas-solid (i.e. two-phase) reactions or gas-liquid-solid (i.e. three-phase) reactions. Reactor 4 may also accommodate CuCl₂ particles of various sizes. Reactor 4 could be operated so that reactants are introduced into reactor 4 from side, top or bottom in order to operate in counter-current or co-current flow patterns. Even though the following description relates specifically to the hydrolysis of CuCl₂ within the Cu—Cl cycle, it is understood that reactor 4 could also be used to carry out other thermochemical processes.

Reactor 4 may be continuously operated or operated in batch mode. In any case, CuCl₂ in a selected form may be supplied as a reactant to reaction chamber 22 of reactor 4 via hopper 60 and through inner passage 64 of primary inlet 28. A co-flowing carrier gas which may or may not be a reactant such as for example, steam, nitrogen or other exhaust gas(es) may be injected into reaction chamber 22 via outer passage 68 of primary inlet 28. CuCl₂ may be supplied to first zone 24 of reaction chamber 22.

First zone 24 of reaction chamber 22 may be used to perform various operations. For example, first zone 24 may be used to perform a drying operation of CuCl₂ particles if necessary, a spray operation and/or a falling particle operation. Dispersion inlet(s) 30 may be used to inject steam (i.e. reactant) into first zone 24. Dispersion inlet(s) 30 may be oriented to direct steam towards CuCl₂ entering first zone 24 and be configured to cause CuCl₂ particles to become dispersed within first zone 24. Dispersion inlet(s) 30 may each have an axis 30a and primary inlet 28 may have an axis 28a. Dispersion inlet(s) 30 may be oriented at an angle from primary inlet 28 and may be distributed around primary inlet 28. Dispersion inlet(s) 30 and primary inlet 28 may be oriented so that the axis 30a of each dispersion inlet(s) 30 intersects axis 28a of primary inlet 28 within first zone 24. Dispersion inlet(s) 30 may also be disposed along a side wall of reaction chamber 22. Primary inlet 28 may be configured to extend to various elevations within reaction chamber 22. However, having primary inlet 28 and dispersion inlet(s) 30 disposed at a substantially similar elevation within reaction chamber 22 may result in a relatively good dispersion when the feedstock is a slurry. The relative orientation of primary inlet 28 and dispersion inlet(s) 30 may range from 0° to 90°. Preferably, the relative orientation may range from 30° to 60°.

First zone 24 may be disposed vertically above second zone 26. Depending on the operation to be conducted within first zone 24, the flow rate and the temperature of steam through dispersion inlet(s) 30 and primary inlet 28 may be selected accordingly. More energy may be required if the CuCl₂ particles must also be dried in reactor 4 prior to the hydrolysis process. For example, at a given steam temperature, a higher flow rate of steam may be required through dispersion inlet(s) 30 to conduct a drying operation of the CuCl₂ particles provided as a slurry as opposed to CuCl₂ particles provided as solid particles.

Second zone 26 of reaction chamber 22 may also be used to perform various operations. For example, second zone 26 may be used to perform fluidized, fixed and/or moving bed operations. Therefore, subsequent to or during a first operation taking place in first zone 24, CuCl₂ particles may travel from first zone 24 to second zone 26 and a second operation may be conducted in second zone 26. In the case where second zone 26 is disposed below first zone 24, gravity may cause CuCl₂ particles to travel to second zone 26. Also, depending on the operation taking place in second zone 26, CuCl₂ particles could potentially be temporarily forced back into first zone 24 due, for example, to the fluidizing of a bed in second zone 26.

The flow rate and temperature of the steam entering various inlets (e.g. primary inlet(s) 28, dispersion inlet(s) 30 and distributor nozzle(s) 42) may be used to achieve and control a desired type of operation in first zone 24 and second zone 26. For example, the flow rate of steam through dispersion inlet(s) 30 may be selected to achieve and maintain a drying operation or a spray operation so that at least a portion of the hydrolysis reaction may be conducted in first zone 24. Also, the flow rate of steam through distributor nozzle(s) 42 may be selected to achieve and maintain a fluidized, fixed or moving bed in second zone 26 in order to carry out the hydrolysis reaction. Further, proper selection of flow rates through dispersion inlet(s) 30 and distributor nozzle(s) 42 may be used to achieve and maintain a falling particle operation in first zone 24 so as to conduct at least a portion of the hydrolysis reaction in first zone 24. It is apparent that operating parameters may be adjusted in order to achieve various combinations of operations within first zone 24 and second zone 26 of reaction chamber 22 either individually or simultaneously.

Reactor 4 allows for the required heat to be provided from various sources such as source(s) 98. Steam introduced into reaction chamber 22 may be provided in the form of a gas mixture containing steam. The gas mixture may be a product of an unrelated industrial process and may additionally carry waste heat from the industrial process. For example, exhaust gas(es) containing steam released from suitable heat source(s) 98 as described above may be used. The flow rate of such gas mixture(s) introduced into reaction chamber 22 may be selected so that at least a minimum amount of steam required for completing the reaction is provided. For example, the amount of steam provided may be at, or in excess of, the stoichiometric amount. Further, the carbon dioxide in such exhaust gas(es) may be concentrated with the removal/use of steam during hydrolysis and, consequently, this can be advantageous for sequestration processes or methanol production with CO₂. Also, there may be no need to use additional water as feedstock to the hydrolysis process or even to the overall Cu—Cl cycle. Therefore, no or less additional heat may be required to evaporate water from CuCl₂ particles. The various modes of operation of reactor 4 may, in some applications, also allow reactor 4 to receive exhaust gases that have no or small portion of steam into the hydrolysis reaction for the purpose of recovering heat carried by such gases.

Another potential source of steam may be from exhaust gas(es) exiting natural gas power stations. Again, such exhaust gas(es) could be used as the feedstock to the hydrolysis reaction and also for the overall Cu—Cl cycle. Depending on the type of exhaust gas(es) used (i.e. whether it is steam rich or poor), different forms of water and CuCl₂ could be supplied to reactor 4. For example, such exhaust gas(es) could be introduced into first zone 24 of reactor 4 to spray or atomize the CuCl₂ solution in patterns in order to achieve a spray operation. Alternatively or in combination, such exhaust gas(es) could simultaneously be introduced into second zone 26 to enhance fluidization quality and stability of a fluidized, fixed or moving bed.

At the temperature range of 150-650° C., N₂, O₂ and CO₂, which are typically the major constituents in exhaust gases of combustors may be inert to the hydrolysis reaction. Reactor 4 may allow for the integration of the Cu—Cl cycle with equipment that utilizes hydrocarbon combustors, such as gas power plants and bitumen upgraders.

Reactor 4 also provides multiple heat transfer routes for the hydrolysis reaction. The structure of reactor 4 provides the flexibility of utilizing various forms of heat input that may be required depending on the forms of water and CuCl₂ provided. For example, heat can be either transferred to the reactants through the reactor wall, or directly by the incoming high temperature reactant (e.g. steam) that may carry sufficient heat, or by any heating methods or any combinations of heat inputs. For example, heating jacket 39 may be used to transfer heat from a working fluid into reaction chamber 22. Heating jacket 39 may supplement the heat supply if the steam alone cannot provide sufficient energy for the hydrolysis reaction to take place. Heating jacket 39 may also permit the integration of various heating sources such as heat source(s) 98 with thermochemical reactor 4 and hence the Cu—Cl cycle. Heating jacket 39 may provide another means for transferring heat from an industrial process to the reaction chamber.

To minimize the heat loss, thermal insulation 55 may be disposed on at least a portion of the outside wall of heating jacket 39. When a heating medium such as a high temperature thermal fluid flows through heating jacket 39 via heating jacket inlet 41 and heating jacket outlet 43, heat carried by the heating medium may be transferred to the hydrolysis reaction through a wall of reaction chamber 22. An outlet temperature of thermal fluid flowing through heating jacket 39 at heating jacket outlet 43 may be in the range of 350-450° C. and preferably between 400-420° C. For example, the heating medium could be supercritical water from supercritical water-cooled nuclear reactor (not shown), molten salt or thermal oil from a solar tower (not shown), or high pressure gas from a solar tower. In large lab scale facility, heating jacket 39 could be replaced by an electrical furnace.

When a fluidized bed operation is conducted within second zone 26, CuCl₂ solid particles with diameter larger than 100 microns may be fed into reactor 4 via primary inlet 28 and may fall to distributor plate 40 or a fluidization zone above distributor plate 40. Steam may be introduced into buffer chamber 38 of reactor 4 via distributor inlet 36, and then pass through the distributor plate 40 via distributor nozzles 42 to enter the fluidization zone within second zone 26 and come into contact with solid particles of CuCl₂ for the hydrolysis reaction. After the reaction, the HCl produced together with unreacted steam and entrained fine particles may exit reactor 4 through gas product outlet 44 and may be directed towards cyclone separator 82 so that solid particles may be separated from the gas product. Other types of separators (not shown) may also be used to separate HCl from steam and other inert gases that may be found in gaseous products produced from the hydrolysis reaction. Solid product may be removed from reaction chamber 22 through solid product outlet 46.

For smaller particles that are in the range of 30-100 microns in diameter, secondary inlet(s) 32 may be used to inject CuCl₂ particles directly into second zone 26 so as to reduce the likelihood of solid particles being entrained towards gas product outlet 44. Secondary inlet 32 may be used for injecting larger particles (e.g. >100 microns) as well. An advantage of using primary inlet(s) 28 instead of secondary inlet(s) 32 is that the particles fed through primary inlet(s) 28 may be heated by the exposure to the upward flowing gas stream. This allows for a portion of the heat carried by HCl and unreacted steam exiting the fluidized bed to be recovered.

The CuCl₂ particle size may be dictated by the upstream production methods (e.g., crystallization, spray drying, or moving bed drying) in the Cu—Cl cycle. Usually crystallization may produce larger diameter particles than spray drying methods. The possibility of using different inlets disposed at different locations within reactor 4 provides reactor 4 with the versatility of accommodating various particle sizes that are produced from various upstream production methods.

When CuCl₂ feedstock is in slurry form and second zone 26 is used for a fluidized bed operation, the slurry may be fed through primary inlet(s) 28. Simultaneously, steam may flow through dispersion inlet(s) 30 to disperse the slurry and separate the solid CuCl₂ particles from the water in the slurry. Then, the solid CuCl₂ particles may fall down to the fluidization zone in second zone 26. During the downward falling process, the CuCl₂ particles may absorb heat from the upward flowing gas and may be partly or completely dried before reaching the fluidization zone. The liquid droplets from the slurry may be partly or completely evaporated by the high temperature of the upward flowing gas(es) and/or by the steam injected through dispersion inlet(s) 30. Accordingly, any dissolved CuCl₂ that may be present in the liquid droplets may form fine solid particles before reaching the fluidization zone. The various uses of primary inlet(s) 28 and dispersion inlet(s) 30 may provide reactor 4 with the versatility of accommodating CuCl₂ feedstock in the form of solid particles, slurry or aqueous solution.

When a fluidized bed is conducted in second zone 26, the height of the fluidization zone may be in the range of 2% to 60% of the total height of reaction chamber 22. The optimum range for the height of the fluidization zone may be between 20% and 40% of the height of reaction chamber 22.

During the fixed bed operation, the quantity of steam required may be reduced and/or the quantity of CuCl₂ in reactor 4 may be increased in comparison with the fluidized bed. In this mode of operation, the diameter of the CuCl₂ solid particles may be larger and the height of the reaction zone may even reach 80% of the height of the reaction chamber 22. The CuCl₂ particles can be either fed from primary inlet(s) 28 or from secondary inlet(s) 32. Steam may be introduced via distributor 34 only and not via dispersion inlet(s) 30 if not required. As reaction product is removed from solid product outlet 46, the multiple layers within the fixed bed zone may progressively move downwardly layer by layer. Consequently, this downward movement of CuCl₂ particles within the fixed bed may create a uniform residence time for CuCl₂ particles so that a uniform quality of CuOCuCl₂ may be produced.

The fixed bed operation may not be ideal in cases where CuCl₂ is in the form of slurry or aqueous solution. Due to the height of the fixed bed zone in reaction chamber 22, the water in the slurry may not get a chance to be evaporated before reaching the fixed bed zone.

Reactor 4 may be operated as a falling particle reactor (i.e. sedimentation tower) to conduct a falling particle operation. A falling particle operation may be conducted in first zone 24 of reaction chamber 22 while a second operation is simultaneously conducted in second zone 26. Alternatively, a falling particle operation may be conducted in both first zone 24 and second zone 26 (i.e. using substantially the entire reaction chamber 22). Accordingly, at least a portion of reaction chamber 22 may be used to conduct a falling particle operation. When CuCl₂ particles are in the range of 1-40 microns the stability of fluidization may be difficult to control and a falling particle operation may be more suitable as opposed to a fluidized or fixed bed operation.

During the falling particle operation, CuCl₂ solid particles typically smaller than 40 microns in diameter may be fed into reaction chamber 22 through primary inlet(s) 28, dispersed by steam injected through dispersion inlet(s) 30 and then slowly fall toward distributor plate 40. During the falling process, the hydrolysis reaction may take place and may achieve completion before the CuCl₂ particles reach distributor plate 40. A major portion of steam may be introduced in reaction chamber 22 through distributor 34. The upward flowing steam may exert a drag force and buoyancy on the CuCl₂ particles to significantly reduce the falling velocity of the CuCl₂ particles so that a sufficient residence time of the CuCl₂ particles may be achieved. The flow rate of the upward flowing steam may be adjusted to achieve desired conditions within reaction chamber 22. There may still exist a turbulent and unstable fluidization zone immediately above distributor plate 40 due to the accumulation of particles (solid product) on it. The solid product CuOCuCl₂ accumulating on distributor plate 40 may be removed continuously or at a desired intervals through solid product outlet 46.

After the hydrolysis reaction is achieved by the falling particle operation, the produced HCl, unreacted steam and entrained fine particles may exit reactor 4 through gas product outlet 44, and then be directed to cyclone separator 82 to separate solid particles from the gaseous product and/or other separators to separate HCl from steam and other inert gases.

If CuCl₂ is provided in the form of a slurry to the falling particle operation, additional steam and/or additional heat may be required to firstly dry the CuCl₂ particles in order for the hydrolysis reaction to take place. Similarly, exhaust gases from hydrocarbon combustor or other processes could also be used in conjunction with the falling particle operation.

Reactor 4 may also be used as a spray reactor to conduct a spray operation in first zone 24 while a second operation simultaneously takes place in second zone 26 or a spray operation may be conducted in both first zone 24 and second zone 26. Accordingly, reactor 4 may be used to conduct a spray operation in substantially the entire reaction chamber 22. A spray operation may be better suited when the CuCl₂ fed into reactor 4 comprises an aqueous solution. In this mode of operation, the temperature and flow rate of the carrier gas flowing through outer passage 68 of primary inlet(s) 28 may be increased so that the aqueous solution of CuCl₂ may be atomized as it exits primary inlet(s) 28. In order to more uniformly atomize and distribute the droplets within reaction chamber 22 and also contribute to the spray operation, steam may also be introduced from dispersion inlet(s) 30 when reactor 4 is used in this mode of operation.

As described above, reactor 4 may be used for various modes of operation and various combinations of modes of operation depending on process requirements. For example, if the CuCl₂ feedstock to reactor 4 is in the form of solid or slurry, a fluidized bed operation and/or a falling particle operation may be more suitable. A fixed bed operation may be more suitable for CuCl₂ in solid form. If the CuCl₂ feedstock is in an aqueous solution form, then a spray operation may be a more suitable mode of operation. A falling particle operation may also work for feedstock in an aqueous solution form but a spray operation may be preferred.

A fixed bed operation may consume a lower quantity of steam than fluidized bed operation and falling particle operation. A spray operation may consume the largest amount of steam in comparison with the fluidized bed or falling particle operation. The ratio of steam to CuCl₂ may be about 1:1 to 8:1 for a fixed bed operation and about 5:1 to 15:1 for a fluidized bed operation or a falling particle operation. For a spray operation, the ratio of steam to CuCl₂ may be about 10:1 to 40:1 due to the requirement of evaporating much liquid water from the CuCl₂ aqueous solution.

The residence time of steam within reaction chamber 22 may decrease linearly with the increase of the steam superficial velocity. In decreasing order the superficial velocity of the steam within reaction chamber 22 may be highest for a falling particle operation followed by a fluidized bed operation and then lowest for a fixed bed operation. The superficial velocity of steam may depend on the type of gas used (i.e. whether pure steam or exhaust gases consisting of CO₂, N₂ and steam are used) and the particle size. If using substantially pure steam, the superficial velocity of steam for a fixed bed operation may be in the range of 0.01-0.15 m/s, 0.15-0.5 m/s for a fluidized bed operation, and about 0.5 m/s or higher for a falling particle operation. For other types of gas species, the operation ranges may be as follows:

U_{superficial}/U_{mf}<1.5, for a fixed bed operation;

U_{superficial}/U_{mf}=1.5-10, for a fluidized bed operation; and

U_{superficial}/U_{mf}>10, for a falling particle operation; where

U_{superficial} is the superficial velocity of upward flowing gas, U_{mf} is the initiation gas velocity of fluidization.

With respect to particle size of CuOCuCl₂ produced via the hydrolysis of CuCl₂, a fixed bed operation may provide better particle size uniformity than a falling particle operation. Also, a falling particle operation bed may provide better particle size uniformity than a fluidized bed operation.

When reactor 4 is used to produce a fixed bed operation or a fluidized bed operation, both primary inlet(s) 28 and secondary inlet(s) 32 may be used for the feeding of CuCl₂. When reactor 4 is used to produce a falling particle operation or spray operation, only primary inlet(s) 28 may be used.

Primary inlet(s) 28 may be used to inject more steam than dispersion inlet(s) 30 for a fixed bed, fluidized bed and falling particle operations. However, when reactor 4 is used as a spray reactor, dispersion inlet(s) 30 may be used to inject more steam than primary inlet 28.

Depending on production scale, the height of reaction chamber 22 may be in the range of 1 to 30 meters. For large lab scale hydrogen production at the level of 0.03-5.0 kg of hydrogen per day, the height of reaction chamber 22 may be 0.6-1.6 meters and the optimum value may be around 1.2 meters. The diameter of reaction chamber 22 for the large lab scale may be around 0.15-0.45 meter and the optimum value may be around 0.25 meter. For industrial hydrogen production at the scale of 50-200 tons per day, the height of reaction chamber 22 may be in the range of 5-30 meters (preferably between 12-20 meters) and the diameter of reaction chamber 22 may be in the range of 0.8-4.5 meters (preferably between 2-3.5 meters).

Materials suitable for the reaction chamber 22 and cyclone separator 82 may include quartz, graphite, silicon carbide, aluminum oxide based fire bricks, and hastalloy C which may withstand the combined corrosion of CuCl₂ particles, Cl₂, and the mixture of steam and HCl at 600° C. A quartz or quartz-lined reaction chamber 22 may be a suitable option for large lab scale facility. Buffer chamber 38 may be constructed from stainless steel 304, 316 or 416 which may be less costly than hastalloy C. Thermal insulation 55 may comprise one or more of insulation bricks, wools and foams which may withstand being exposed to temperatures as high as 1200° C. Base 50 and support frame 52 may be constructed from conventional materials such as steel.

The above description is meant to be exemplary only, and one skilled in the art will recognize that changes may be made to the embodiments described without departing from the scope of the invention disclosed. Modifications which fall within the scope of the present invention will be apparent to those skilled in the art, in light of a review of this disclosure, and such modifications are intended to fall within the appended claims.

What is claimed is:

1. A reactor for use in a thermochemical process, the reactor comprising:
a reaction chamber having:
a first zone comprising at least one first inlet to introduce a first reactant and at least one additional inlet to introduce an additional reactant, the inlets being configured to conduct a spray operation in the first zone; and
a second zone in communication with the first zone;
a distributor to introduce the additional reactant to the second zone; and
at least one product outlet for communication with the reaction chamber.

2. The reactor as defined in claim 1, wherein the at least one first inlet has a first axis and the at least one additional inlet has an additional axis, the first axis intersecting the additional axis within the first zone.

3. The reactor as defined in claim 1, wherein the at least one first inlet and the at least one additional inlet are substantially coaxial.

4. The reactor as defined in claim 1, comprising a third inlet configured to introduce the first reactant to the second zone of the reaction chamber.

5. The reactor as defined in claim 1, wherein the at least one product outlet includes a gas product outlet for communication with the first zone and a solid product outlet for communication with the second zone.

6. The reactor as defined in claim 1, wherein the second zone of the reaction chamber is configured to conduct at least one of a fluidized bed operation and a fixed bed operation.

7. The reactor as defined in claim 1, comprising a heating jacket at least partially surrounding the reaction chamber.

8. The reactor as defined in claim 1, wherein the distributor includes a plurality of nozzles.

9. A thermochemical process comprising:
introducing a first reactant and an additional reactant to a first zone of a reaction chamber and conducting a spray operation in the first zone;
receiving at least a portion of the first reactant and the additional reactant in a second zone of the reaction chamber; and
introducing more of the additional reactant to the second zone to obtain a product.

10. The process as defined in claim 9, wherein the spray operation includes at least partially drying the first reactant.

11. The process as defined in claim 9, wherein the spray operation includes intersecting a stream of the first reactant with a stream of the additional reactant.

12. The process as defined in claim 9, comprising fluidizing a bed in the second zone.

13. The process as defined in claim 9, comprising conducting a fixed bed operation in the second zone.

14. The process as defined in claim 12, wherein the first reactant includes cupric chloride (CuCl₂) and the second reactant includes steam.

15. The process as defined in claim 9, wherein the first reactant includes cupric chloride (CuCl₂) and the second reactant includes a gas mixture containing steam.

16. The process as defined in claim 15, wherein the first reactant is in the form of at least one of a solid, a slurry and an aqueous solution.

17. The process as defined in claim 9, comprising adding heat from an industrial process to the reaction chamber.

18. A process for hydrolysis of cupric chloride (CuCl₂) for use in a thermochemical copper-chlorine (Cu—Cl) cycle, the process comprising:
introducing cupric chloride and steam in a first zone of a reaction chamber and conducting a spray operation in the first zone;
receiving at least a portion of the cupric chloride and the steam in a second zone of the reaction chamber in communication with the first zone; and
introducing additional steam in the second zone to obtain a product in the reaction chamber.

19. The process as defined in claim 18, comprising one of fluidizing a bed in the second zone using the additional steam and conducting a fixed bed operation in the second zone using the additional steam.

20. The process as defined in claim 19, comprising at least partially drying the cupric chloride in the first zone.
